(19) United States
(12) Patent Application Publication
(10) Pub. No.: US 2026/0186950 A1
(43) Pub. Date: Jul. 2, 2026

(54) METHOD FOR PERFORMING CODE REVIEWING WITH AID OF ARTIFICIAL INTELLIGENCE MODEL

(71) Applicant: MEDIATEK INC., Hsinchu City (TW)

(72) Inventors: Chien-Hao Li, Hsinchu City (TW); Yi-Hsi Huang, Hsinchu City (TW); Wen-Hsiang Hsu, Hsinchu City (TW); Tzu-Yee Yang, Hsinchu City (TW); Qin QIN, Chengdu (CN)

(73) Assignee: MEDIATEK INC., Hsinchu City (TW)

(21) Appl. No.: 19/008,557

(22) Filed: Jan. 2, 2025

(51) Int. Cl. G06F 11/362

(52) U.S. Cl. CPC G06F 11/3628

(57) ABSTRACT

A method for performing code reviewing with aid of an AI model includes: receiving multiple codes to be reviewed; according to a specific database related to the multiple codes, guiding the AI model to review each code among the multiple codes to generate a reviewing result; outputting the reviewing result to a user interface; receiving feedback information regarding the reviewing result from the user interface; and according to the feedback information, guiding the AI model to perform a reflection operation.

### BACKGROUND

The present invention is related to code reviewing, and more particularly, to a method for performing code reviewing with aid of an artificial intelligence (AI) model and a non-transitory machine-readable medium for storing a program code that performs the method when executed.

In the process of software development, code reviewing is an important step to ensure code quality. Existing code review software requires manual reviewing to find potential errors in the code, which may consume a lot of time and is susceptible to human factors (e.g., differences in code reviewing quality). As a result, a method for performing code reviewing with aid of an AI model is urgently needed, in order to ensure the code reviewing quality.

### SUMMARY

It is therefore one of the objectives of the present invention to provide a method for performing code reviewing with aid of an AI model, and a non-transitory machine-readable medium for storing a program code that provides the method when executed, to address the above-mentioned issues.

According to an embodiment of the present invention, a method for performing code reviewing with aid of an AI model is provided. The method comprises: receiving multiple codes to be reviewed; according to a specific database related to the multiple codes, guiding the AI model to review each code among the multiple codes to generate a reviewing result; outputting the reviewing result to a user interface; receiving feedback information regarding the reviewing result from the user interface; and according to the feedback information, guiding the AI model to perform a reflection operation.

According to an embodiment of the present invention, a non-transitory machine-readable medium for storing a program code is provided, wherein when loaded and executed by a processor, the program code instructs the processor to perform a method for performing code reviewing with aid of an AI model, and the method comprises: receiving multiple codes to be reviewed; according to a specific database related to the multiple codes, guiding the AI model to review each code among the multiple codes to generate a reviewing result; outputting the reviewing result to a user interface; receiving feedback information regarding the reviewing result from the user interface; and according to the feedback information, guiding the AI model to perform a reflection operation.

One of the objectives of the present invention is that, by the method of the present invention, an AI model may be guided to learn previous code defects, and provide a reviewing result regarding a code defect that may exist in a code to be reviewed, in order to ensure code quality. In addition, by the database of the present invention, the AI model may be guided to generate the reviewing result for indicating software development life cycle (SDLC) data and experience information, and the reviewing result can be provided to a user through a user interface for reference. Furthermore, the code reviewing system of the present invention can be embedded to an original code reviewing process through a check-in control procedure, and the user can intuitively evaluate the reviewing result through the user interface.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to an embodiment of the present invention.

FIG. 2 is a diagram illustrating a code reviewing scheme according to an embodiment of the present invention.

FIG. 3 is a flow chart of a method for performing code reviewing with aid of an AI model according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”.

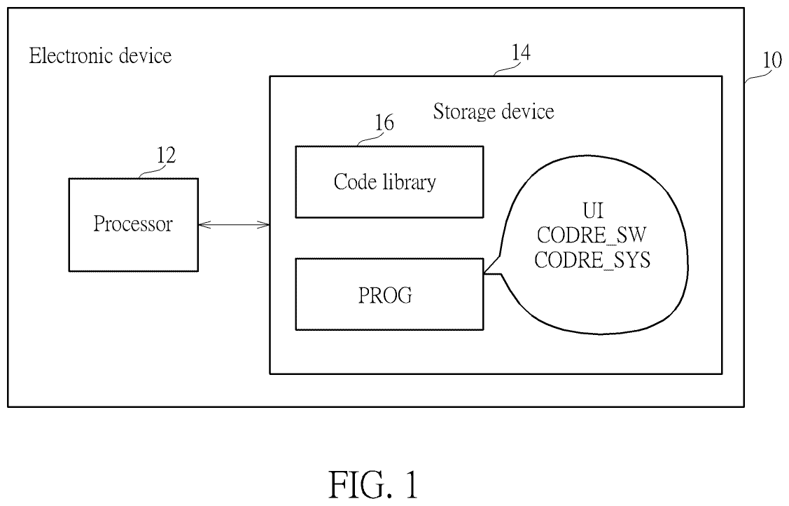

FIG. 1 is a diagram illustrating an electronic device 10 according to an embodiment of the present invention. By way of example, but not limitation, the electronic device 10 may be a tablet computer or a personal computer (e.g., a desktop computer and a laptop computer). The electronic device 10 may include a processor 12 and a storage device 14. The processor 12 may be a single-core processor or a multi-core processor. The storage device 14 is a non-transitory machine-readable medium, and is arranged to store computer program code PROG. The storage device 14 may include a code library 16, wherein a user may store multiple codes to be reviewed in the code library 16. The processor 12 is equipped with software execution capability.

The computer program code prog may include a plurality of software modules. As a result, when loaded and executed by the processor 12, the computer program code PROG instructs the processor 12 to perform designated functions of the software modules. For example, the software modules may include a user interface (labeled as “UI” in FIG. 1 for brevity), a code reviewing software module (labeled as “CODRE_SW” in FIG. 1 for brevity), and a code reviewing system as proposed by the present invention (labeled as “CODRE_SYS” in FIG. 1 for brevity). The user may interact with the code reviewing system through the user interface. For example, the user may receive a reviewing result generated by the code reviewing system through the user interface, and may provide feedback information regarding the reviewing result to the code reviewing system through the user interface, wherein the feedback information may include feedback questionnaires filled out by the user regarding the reviewing result, so that the code reviewing system may perform a reflection operation according to the feedback information, in order to update associated database included in the code reviewing system for improving code reviewing quality. The code reviewing system may be arranged to perform a method for performing code reviewing with aid of an artificial intelligence (AI) model. That is, the original code reviewing operation may be improved in quality from the code reviewing software module to the code reviewing system. According to the reviewing result, the user may modify the multiple codes to be reviewed on the code reviewing software module, and the code reviewing system may generate a report corresponding to the multiple codes. The electronic device 10 may be regarded as a computer system using a computer program product that includes a computer-readable medium containing the computer program code PROG. That is, the method and the code reviewing system of the present invention may be embodied on the electronic device 10.

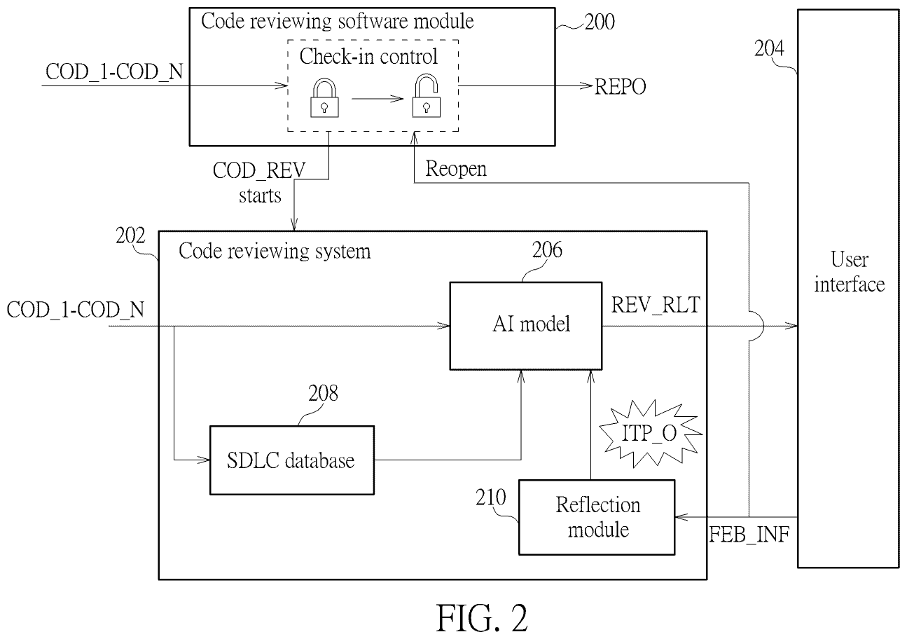

FIG. 2 is a diagram illustrating a code reviewing scheme according to an embodiment of the present invention. As shown in FIG. 2, the processor 12 may be arranged to execute a code reviewing software module 200, a code reviewing system 202, and a user interface 204. In the beginning, the code reviewing software module 200 may receive multiple codes to be reviewed COD_1-COD_N from the code library 16, wherein “N” may be an integer greater than one. In response to the codes COD_1-COD_N being received through the code reviewing software module 200, a check-in control procedure (labeled as “Check-in control” in FIG. 2 for brevity) may be performed for starting to perform a code reviewing flow regarding the codes COD_1-COD_N through the code reviewing system 202 (labeled as “COD_REV starts” in FIG. 2 for brevity) and closing a permission to modify the codes COD_1-COD_N on the code reviewing software module 200.

The code reviewing system 202 may include an AI model 206, a software development life cycle (SDLC) database 208, and a reflection module 210. During the code reviewing flow, the AI model 206 may first receive the codes COD_1-COD_N from the code library 16, and multiple guiding (or prompting) operations may be performed upon the AI model 206 to generate a reviewing result REV_RLT. Specifically, the SDLC database 208 may include information related to the codes COD_1-COD_N, including SDLC data and experience information, application programming interface (API) usage risk information, information related to plan, do, check and act (PDCA) of software development, and multiple groups of code detects, wherein the groups of code detects may be related to code defects frequently made by a developer. According to the SDLC database 208, the AI model can be guided to review each code among the codes COD_1-COD_N in order to generate the reviewing result REV_RLT.

In some embodiments, the SDLC database 208 may further include code changing related information and software ipized related information, wherein the code changing related information may be information related to hardware, software change requirements, and previous code changing thereof. By guiding the AI model 206 according to the code changing related information, the user may determine whether new code changing is similar to the previous code changing according to the reviewing result REV_RLT, in order to avoid happening of similar errors.

Each group of code defects among the multiple groups of code detects included in the SDLC database 208 may include multiple types of code defects. Examples of the multiple types of code defects may include, but are not limited to: uninitialized variable, null pointer dereference, buffer overflow, memory leak, resource leak, use after free, numeric error, race condition, exception handling, incorrect function return value, function argument mismatch, mismatched function pair calls, resource management, improper logging order, control flow, dead code, and code security.

For example, the SDLC database 208 may include three groups of code detects, wherein uninitialized variable, null pointer dereference, buffer overflow, memory leak, resource leak, and use after free may be classified into the 1^{st} group of code detects;, numeric error, race condition, exception handling, incorrect function return value, function argument mismatch, and mismatched function pair calls may be classified into the 2^{nd} group of code detects; resource management, improper logging order, control flow, dead code, and code security may be classified into the 3^{rd} group of code detects. The AI model 206 may determine whether each code among the codes COD_1-COD_N exists any code defect in the 1^{st} group of code detects in order to generate a first determination result; determine whether the each code exists any code defect in the 2^{nd} group of code detects in order to generate a second determination result; and determine whether the each code exists any code defect in the 3^{rd} group of code detects in order to generate a third determination result. However, this is for illustrative purposes only, and is not meant to be a limitation of the present invention. In some embodiments, the number of groups of code detects included in the SDLC database 208 may vary, depending upon actual design considerations.

Afterwards, the AI model 206 may generate the reviewing result REV_RLT according to the first determination result, the second determination result, and the third determination result, wherein the reviewing result REV_RLT may be indicative of a code defect type (e.g., which type of code defect is most likely to be at risk for the code), a code defect file name, a code defect function name, and a code defect source code of the code, and may include a solution corresponding to a code detect existed in the code. Compared with a case where it is determined whether the code exists a corresponding code defect according to each code defect type, utilizing multiple groups of code defects to perform the determination operation upon the code has a higher accuracy of the reviewing result REV_RLT.

The reflection module 210 may guide the AI model 206 to perform a reflection operation according to the reviewing result REV_RLT. In order to improve code reviewing quality, the reviewing result REV_RLT may be output to the user interface 204, and the user may check the reviewing result REV_RLT and provide feedback information FEB_INF regarding the reviewing result REV_RLT to the code reviewing system 202 through the user interface 204. The reflection module 210 may receive the feedback information FEB_INF from the user interface 204, and guide the AI model 206 to perform the reflection operation (labeled as “ITP_O” in FIG. 2 for brevity) according to the feedback information FEB_INF. For example, the AI model 206 may update the SDLC database 208 according to the feedback information FEB_INF, and generate the reviewing result REV_RLT according to updated SDLC database 208, in order to make the reviewing result REV_RLT closer to the user's preferences.

In addition, in response to the feedback information FEB_INF being received, the permission to modify the codes COD_1-COD_N on the code reviewing software module 200 is reopened through the check-in control procedure (labeled as “Reopen” in FIG. 2 for brevity), and the user may modify the codes COD_1-COD_N on the code reviewing software module 200 according to the reviewing result REV_RLT (more particularly, the feedback information FEB_INF), for generating a report REPO corresponding to the codes COD_1-COD_N. For example, based on the feedback information FEB_INF, a quality indicator and a corresponding dashboard may be generated, and a scheme may be formulated according to the dashboard for improving the code reviewing quality of the code reviewing system 202.

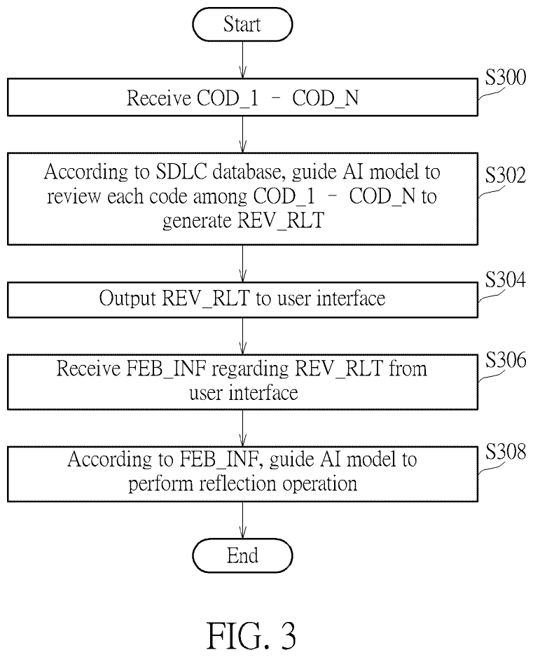

FIG. 3 is a flow chart of a method for performing code reviewing with aid of an AI model according to an embodiment of the present invention. Provided that the result is substantially the same, the steps are not required to be executed in the exact order shown in FIG. 3. For example, the method shown in FIG. 3 may be employed by the electronic device 10 shown in FIG. 1 (more particularly, the code reviewing system 202 shown in FIG. 2).

In Step S300, the codes to be reviewed COD_1-COD_N are received by the code reviewing system 202.

In Step S302, according to the SDLC database 208, the AI model 206 is guided to review each code among the codes COD_1-COD_N to generate the reviewing result REV_RLT.

In Step S304, the reviewing result REV_RLT is output to the user interface 204 by the AI model 206.

In Step S306, the feedback information FEB_INF regarding the reviewing result REV_RLT is received from the user interface 204 by the reflection module 210.

In Step S308, according to the feedback information FEB_INF, the AI model 206 is guided to perform a reflection operation by the reflection module 210.

Since a person skilled in the pertinent art can readily understand details of the steps after reading above paragraphs, further description is omitted here for brevity.

In summary, by the method of the present invention, an AI model may be guided to learn previous code defects, and provide a reviewing result regarding a code defect that may exist in a code to be reviewed, in order to ensure code quality. In addition, by the database of the present invention, the AI model may be guided to generate the reviewing result for indicating SDLC data and experience information, and the reviewing result can be provided to a user through a user interface for reference. Furthermore, the code reviewing system of the present invention can be embedded to an original code reviewing process through a check-in control procedure, and the user can intuitively evaluate the reviewing result through the user interface.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing code reviewing with aid of an artificial intelligence (AI) model, comprising:
receiving multiple codes to be reviewed;
according to a specific database related to the multiple codes, guiding the AI model to review each code among the multiple codes to generate a reviewing result; and
according to the reviewing result, guiding the AI model to perform a reflection operation.

2. The method of claim 1, wherein the specific database comprises multiple groups of code defects, each group of code defects among the multiple groups of code defects comprises multiple code defects, and the step of according to the specific database related to the multiple codes, guiding the AI model to review the each code among the multiple codes to generate the reviewing result comprises:
for the each group of code defects, determining whether the each code exists any code defect among the each group of code defects, to generate a determination result; and
generating the reviewing result according to multiple determination results.

3. The method of claim 1, wherein the specific database is a software development life cycle (SDLC) database.

4. The method of claim 1, wherein the reviewing result comprises a solution corresponding to a code detect existed in the each code, and is indicative of a code defect type, a code defect file name, a code defect function name, and a code defect source code of the each code.

5. The method of claim 1, further comprising:
executing a code reviewing software module for generating a report corresponding to the multiple codes according to the reviewing result; and
in response to the multiple codes being received through the code reviewing software module, performing a check-in control procedure for starting to generate the reviewing result with aid of the AI model and closing a permission to modify the multiple codes on the code reviewing software module.

6. The method of claim 1, wherein the step of according to the reviewing result, guiding the AI model to perform the reflection operation comprises:
outputting the reviewing result to a user interface;
receiving feedback information regarding the reviewing result from the user interface; and
according to the feedback information, guiding the AI model to perform the reflection operation.

7. The method of claim 6, further comprising:
in response to the feedback information being received, opening a permission to modify the multiple codes on a code reviewing software module through a check-in control procedure.

8. A non-transitory machine-readable medium for storing a program code, wherein when loaded and executed by a processor, the program code instructs the processor to perform a method for performing code reviewing with aid of an artificial intelligence (AI) model, and the method comprises:
receiving multiple codes to be reviewed;
according to a specific database related to the multiple codes, guiding the AI model to review each code among the multiple codes to generate a reviewing result; and
according to the reviewing result, guiding the AI model to perform a reflection operation.

9. The non-transitory machine-readable medium of claim 8, wherein the specific database comprises multiple groups of code defects, each group of code defects among the multiple groups of code defects comprises multiple code defects, and the step of according to the specific database related to the multiple codes, guiding the AI model to review the each code among the multiple codes to generate the reviewing result comprises:
for the each group of code defects, determining whether the each code exists any code defect among the each group of code defects, to generate a determination result; and
generating the reviewing result according to multiple determination results.

10. The non-transitory machine-readable medium of claim 8, wherein the specific database is a software development life cycle (SDLC) database.

11. The non-transitory machine-readable medium of claim 8, wherein the reviewing result comprises a solution corresponding to a code detect existed in the each code, and is indicative of a code defect type, a code defect file name, a code defect function name, and a code defect source code of the each code.

12. The non-transitory machine-readable medium of claim 8, wherein the method further comprises:
executing a code reviewing software module for generating a report corresponding to the multiple codes according to the reviewing result; and
in response to the multiple codes being received through the code reviewing software module, performing a check-in control procedure for starting to generate the reviewing result with aid of the AI model and closing a permission to modify the multiple codes on the code reviewing software module.

13. The non-transitory machine-readable medium of claim 8, wherein the step of according to the feedback information, guiding the AI model to perform the reflection operation comprises:
outputting the reviewing result to a user interface;
receiving feedback information regarding the reviewing result from the user interface; and
according to the feedback information, guiding the AI model to perform the reflection operation.

14. The non-transitory machine-readable medium of claim 13, wherein the method further comprises:
in response to the feedback information being received, opening a permission to modify the multiple codes on a code reviewing software module through a check-in control procedure.

15. A code reviewing system, wherein the code reviewing system is executed by a processor, and comprises:
an artificial intelligence (AI) model, arranged to receive multiple codes to be reviewed;
a specific database related to the multiple codes, wherein according to the specific database, the AI model is guided to review each code among the multiple codes to generate a reviewing result; and
a reflection module, arranged to guide the AI model to perform a reflection operation according to the reviewing result.

16. The code reviewing system of claim 15, wherein the specific database comprises multiple groups of code defects, and each group of code defects among the multiple groups of code defects comprises multiple code defects; for the each group of code defects, the AI model determines whether the each code exists any code defect among the each group of code defects, to generate a determination result; and the AI model generates the reviewing result according to multiple determination results.

17. The code reviewing system of claim 15, wherein the specific database is a software development life cycle (SDLC) database.

18. The code reviewing system of claim 15, wherein the reviewing result comprises a solution corresponding to a code detect existed in the each code, and is indicative of a code defect type, a code defect file name, a code defect function name, and a code defect source code of the each code.

19. The code reviewing system of claim 15, wherein the processor further executes a code reviewing software module for generating a report corresponding to the multiple codes according to the reviewing result; and in response to the multiple codes being received through the code reviewing software module, a check-in control procedure is performed for starting to generate the reviewing result with aid of the AI model, and a permission for modifying the multiple codes on the code reviewing software module is closed.

20. The code reviewing system of claim 15, wherein the processor further performs a user interface, the AI model is further arranged to output the reviewing result to the user interface, and the reflection module is further arranged to:
receive feedback information regarding the reviewing result from the user interface; and
according to the feedback information, guide the AI model to perform the reflection operation.

21. The code reviewing system of claim 20, wherein in response to the feedback information being received, a permission for modifying the multiple codes on a code reviewing software module is opened through a check-in control procedure.
